(19) United States
(12) Patent Application Publication
(10) Pub. No.: US 2005/0073179 A1
(43) Pub. Date: Apr. 7, 2005

(54) Selective automotive top

(76) Inventor: Morgan Dewey Williams, Tempe, AZ (US)

Correspondence Address: Morgan D. Williams, P.O. Box 25983, Tempe, AZ, 85285, US

(21) Appl. No.: 10/678,929

(22) Filed: Oct. 6, 2003

(51) Int. Cl. B60J 7/11

(52) U.S. Cl. 296/218

(57) ABSTRACT

A top for overhead area of vehicle occupant compartment having a defined roof aperture including; a most forward position, a most rearward position and two additional sides opposite of one another with corresponding ends adjacent to corresponding ends of said forward and rear positions. For occupants of an automobile with said defined roof aperture, said top provides unique conditions of protection in the environment produce by those automobiles.

### CROSS-REFERENCE TO RELATED APPLICATIONS

Not Applicable

### STATEMENT REGUARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention relates to removable tops for motor vehicles. More particularly the invention focuses on producing an alternate environment that provides protection for a vehicle occupant while the automobile is in use. Currently automobiles with removable tops can either put the tops up or down. When the tops are up they provide blockage from elements, when they are down they provide what is known in the industry as an open-air ride. The open-air ride does come at some cost to the consumer, for example over exposure.

### BRIEF SUMMARY OF THE INVENTION

The present invention produces a top for overhead area of vehicle occupant compartment having a defined roof aperture including; a most forward position, a most rearward position and two additional sides opposite of one another with corresponding ends adjacent to corresponding ends of forward and rear sides. Recognizing that the experience of the open-air ride produced by automobiles with removable tops appeal to consumers the disclosed top was developed. The disclosed invention addresses the issue of element exposure while maintaining an open-air ride. For example while providing an open-air ride the top also allows for reduced amounts of element exposure to occupants.

### BREIF DESCRIPTION OF THE SEVERAL VIEWS OF THE DRAWING

Cover image is an illustrational view of a vehicle with a selective automotive top; dotted lines show the continuation of vehicle structure.

FIG. 1 shows the relation of an overhead area of a vehicle occupant compartment and said top; view of said top is enlarged and vehicle used is for illustrative purposes only.

FIG. 2 is a view of the support-ply.

### DETAILED DESCRIPTION OF THE INVENTION

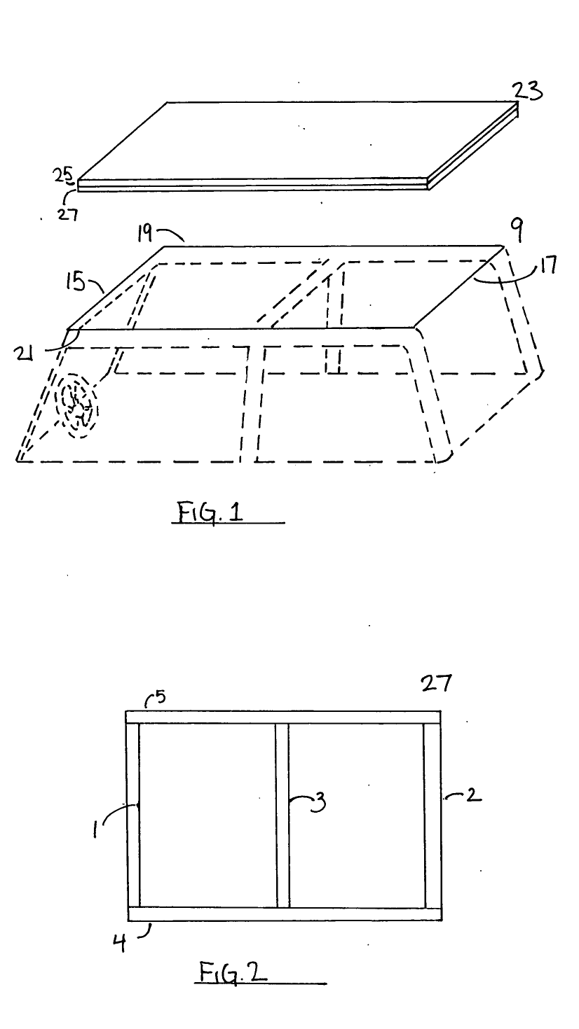

The discussed invention produces a means to alter an automobiles atmosphere providing protection for the vehicles occupants. A defined roof aperture 9 in the overhead area of a vehicle occupant compartment includes a most forward location 15, a most rear location 17, at least one side 19 that is transverse to the forward location 15 and rear location 17 and another side 21 that is transverse to the forward location 15 and rear location 17, seen in FIG. 1.

FIG. 1 shows the relation between an overhead roof aperture 9 and the top 23. The top 23 includes at least one ply 25 bonded by means of attaching to at least one support-ply 27. At least one ply 25 expands the area of overhead roof aperture 9 and shares perimeter dimensions with at least one support-ply 27. At least one ply 25 is suitable as a solar radiation filter. At least one ply 25 allows for air permeation.

At least one support-ply 27 seen in FIG. 2 includes; a support member 1 in the most forward location of support-ply 27 and possesses means to attach to vehicle, a support member 2 in the most rearward location of support-ply possesses means to attach to vehicle. At least one mid-support member 3 on a corresponding axis and between support member 1 and 2, mid-support member 3 possesses means to attach to vehicle, at least one lateral support member 4 extends from front to rear of support-ply 27 with said forward end of lateral support member 4 joining at least one corresponding end of forward support member 1 and said rearward end of lateral support member 4 joining at least one corresponding end of rearward support member 2, at least one corresponding end of mid-support member 3 joins lateral support member 4 there in between lateral support members forward and rearward ends, lateral support member 4 possesses means to attach to vehicle, the other lateral support member 5 extends from front to rear of support-ply 27 with said forward end joining the other end of forward support member 1 and said rearward end of lateral support member 5 joining the other end of rearward support member 2, the other end of mid-support member 3 joins said lateral support member 5 there in between said forward and rearward ends, lateral support member 5 possesses means to attach to vehicle. Support-ply 27 possesses tensioning ability.

1. A roof covering for a defined roof aperture above vehicle occupant compartment having, a most forward position, a most rear position and two sides opposite one another and transverse to the front and rear includes; a flexible and foldable roof covering of at least one ply construction, of which said plies share perimeter dimensions, said construction is bonded by means of attaching to form a structure referred to as a top, said top provides protection for a vehicles occupants.

2. At least one ply of top expands said area described in claim 1.

3. At least one ply of said top described in claim 2 is suitable as a solar radiation filter allowing reduced amounts of UV to permeate said ply embodiment.

4. At least one ply of said top described in claim 2 is suitable as an air-flow filter allowing reduced amounts of air to permeate said ply embodiment.

5. At least one ply of top described in claim 1 derived from linked support members, said embodiment possesses a tension capability, said ply is referred to as a support-ply.

6. Support-ply as described in claim 5 includes; a forward support member being said front of support-ply and possessing means to attach to vehicle, a rearward support member being rear of support-ply and possessing means to attach to vehicle, at least one mid-support member positioned between forward and rearward support members and possessing means to attach to vehicle, at least one lateral support member extends from front to rear of support-ply with said forward end of lateral support member joining at least one corresponding end of forward support member and said rearward end of lateral support member joining at least one corresponding end of rearward support member, at least one corresponding end of mid-support member joins lateral support member there in between lateral support members forward and rearward ends, lateral support member possesses means to attach to vehicle, the other lateral support member extends from front to rear of support-ply with said forward end joining the other end of forward support member and said rearward end of lateral support member joining the other end of rearward support member, the other end of mid-support member joins said lateral support member there in between said forward and rearward ends, lateral support member possesses means to attach to vehicle.
